(19) United States
(12) Patent Application Publication
(10) Pub. No.: US 2022/0405795 A1
(43) Pub. Date: Dec. 22, 2022

(54) Creator Selection Application

(71) Applicant: Jeffrey Overall, Costa Mesa, CA (US)

(72) Inventor: Jeffrey Overall, Fountain Valley, CA (US)

(73) Assignee: Polar Pro Filters, Inc., Costa Mesa, CA (US)

(21) Appl. No.: 17/354,651

(22) Filed: Jun. 22, 2021

(51) Int. Cl. G06Q 30/02; G06F 9/54

(52) U.S. Cl. CPC G06Q 30/0224; G06F 9/547

(57) ABSTRACT

A software application to automate a company's selection of endorsers and promotional material content creators. The application utilizes Application Programming Interfaces (API's) to communicate with and extract user data from third party user content websites. The application processes the data and assigns a creator a creator tag based on the processed data. A brand inputs promotions to the application. The creator tag is used to match creators and promotions.

### FIELD OF INVENTION

The invention relates to the use of software to improve the efficiency of online brand promotion. Specifically, the disclosed invention relates to software implemented applications utilizing user data made accessible through website API's to automate part of the brand promotor selection process.

### BACKGROUND

Advertising continues to shift from old, mass media (TV, print, radio) to new, niche media (social media, user generated content websites, podcasts, etc.). Social media and other user generated content platforms allow brands to accurately target their customer demographic when advertising.

In this new landscape it is vital that brands select content creators that both appeal to their customer demographic and can reach that customer demographic. Currently, discovering creators and endorsers has been done manually—either by a brand manually contacting the creator or the creator manually contacting the brand. Either method requires a brand commit personnel to manually evaluate the commercial value of the creator by accessing their content platforms to confirm or discover information about the creator. The process requires an unnecessary amount of human capital and subjective evaluation. The current invention automates a large part of this process.

Application Programming Interfaces (APIs) enable software applications to interface. APIs enable extraction of user data from social media and other platforms on which content is featured. Software exists that utilizes APIs to automate the extraction of data from websites. APIs for media companies such as Facebook, Inc. and user content platforms such as Alphabet Inc.'s YouTube® allow extraction of user data such as followers, subscribers, views, participation rate, and other metric data indicative of the commercial potential of a creator.

The current invention a software application that uses APIs to partially automate the endorser selection process.

### SUMMARY

The current invention is a software application improving a brand's ability to evaluate creators of content as endorsers. The application may be either native or web-based. Multiple brand modules may live on an application server. A brand interface enables a brand to upload promotional content projects, discount activations, ambassador team qualifications, and other promotions. The creator manually inputs preliminary data. Preliminary data may include account information for the creator's social media profiles (Instagram, tik tok, facebook), personal website, or third-party content creator websites (Youtube). The preliminary data is stored in the brand module.

Application Programming Interface (API) connectors are stored within a server. Each API connector is written to call and communicate with the API endpoint(s) of a specific website (ex: Instagram, tik tok). After the preliminary information has been input, one or more API connectors requests the preliminary information and additional creator metrics from the website's endpoint APIs. The API connector may verify some or all of the creator's preliminary data and extract additional creator metric data, such as followers and views.

Extracted creator metric data is transmitted back to the application server. A tag module in the brand module processes some or all the metric data, whereby a creator tag is produced. The creator tag is stored in a tag module. A specific tag module may qualify the creator for a project, discount, or other promotion uploaded by the brand via a brand interface. The tag module may send the creator a notification of their qualification to an outside communication point, such as email, or as a communication accessible through the creator interface. The creator may then accept or reject the promotion.

### BRIEF DESCRIPTION OF THE DRAWINGS

FIG. 1 is a flow chart of an individual brand module on a creator selection application.

FIG. 2 is a flow chart of a creator tag subsystem of the creator selection application.

FIG. 3 is a flow chart of a discount subsystem of the creator selection application.

FIG. 4 is a flow chart of a pro team subsystem of the creator selection application.

FIG. 5 is a flow chart of a project subsystem of the creator selection application.

FIG. 6 is a high-level flow chart of the creator selection application.

### DRAWING NUMERALS

10 Application Server
50 Creator
52 Unique Identification
60 Brand
100 Brand Module
110 Content Platform Server
112 Content Platform API
120 Third Party e-commerce platform
140 Third Party communications server
160 Brand Interface
170 Promotion Module
180 Creator Interface
182 Message Node
184 Preliminary Database
188 API Connector Module
190 API Connector
192 Metric Database
194 Tag Module
196 Creator Tag Database
198 Promotional Project Qualification
200 Brand Website
202 Website Discount Database
210 Discount Module
211 Brand Website API connector
212 Discount Engine (may be unnecessary)
214 Discount Database
216 e-commerce platform API Connector
217 Sales Platform Server
218 Platform Endpoint
220 Project Module
230 Pro Team Module
232 Pro Team Key
290 Data Node
292 Data Synchronizer
500 Internet

### DETAILED DESCRIPTION OF DRAWINGS

The application may be web-based, meaning the application runs on a web server. Both the creator 50 and brand 60 may access web server via the internet using HTTP, or other protocol.

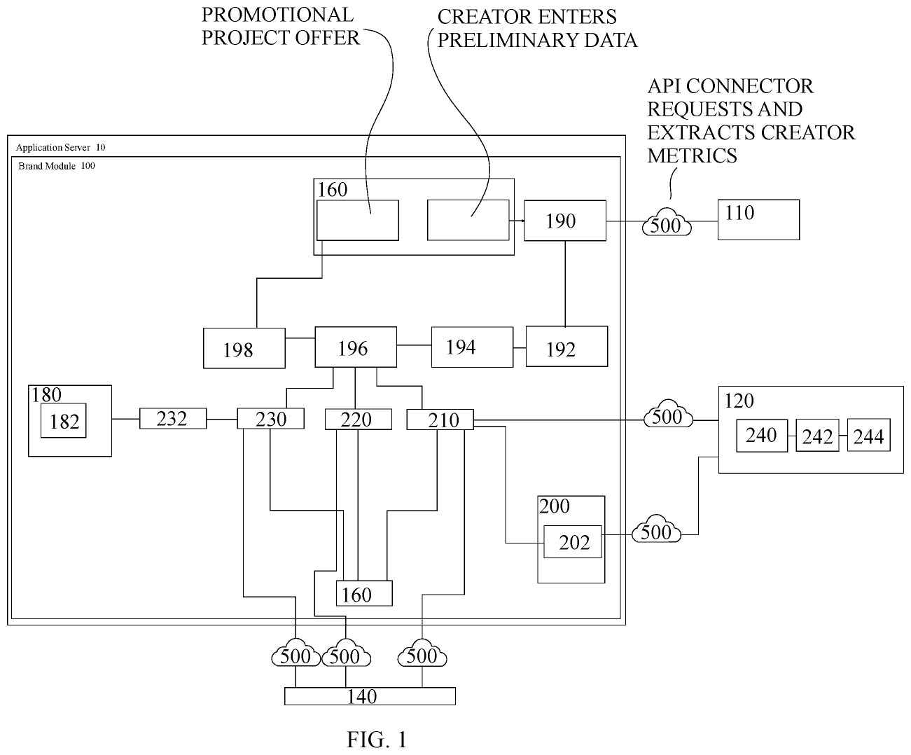

A high-level architecture of the application is depicted in FIG. 1. A creator 50 may access the application via any internet 500 enabled device. The creator 50 may input preliminary data into a creator interface 180. Based on the preliminary data, an API connector module 188 may activate one or more API connector(s) 190. The API connector(s) 190 may call, i.e. request, data from the server of a third party content provider 110. The data may be extracted and persist on a metric database 192. The metric data may be validated and cleansed by one or more node. The data may then be transferred to a tag module 194. The tag module 194 may run data through models and/or algorithms that pertain to creator classification and desirability. The models and algorithms may be entered by a brand 60 via a brand interface 160 on the brand module 100. The tag module 194 may create a creator tag based on the analyzed metric data. The creator tag may be stored in a creator tag database 196, where it may be accessed or retrieved. The application may utilize modular programming, with the separation of functionality into independent, interchangeable modules. Each module may be able to execute one or multiple aspects of the program functionality.

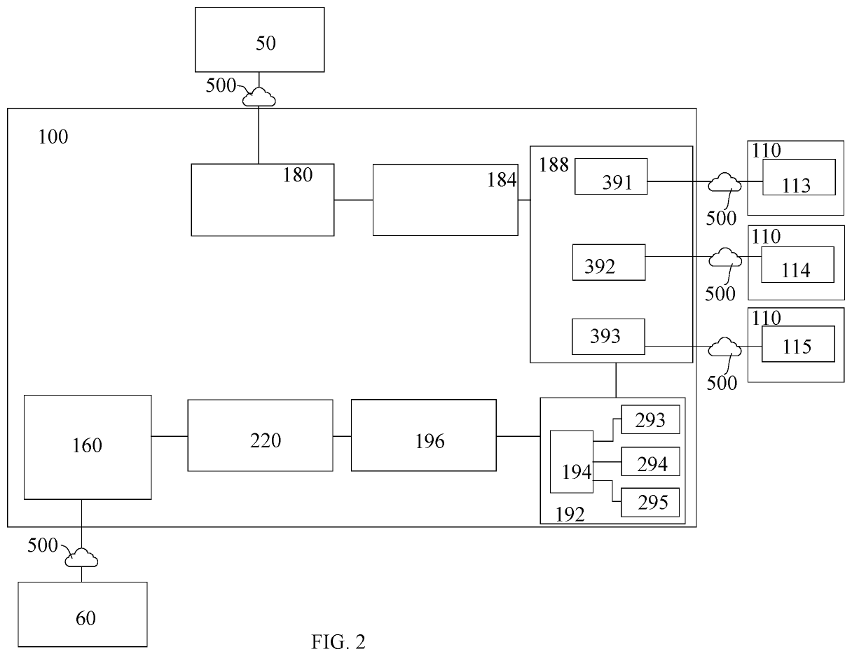

A tag generation subsystem of the application is depicted in FIG. 2. Subsystems may comprise a certain functionality or functionalities of the app. A creator 50 may access the brand module 100 via a creator interface 180. During an onboarding process, the creator 50 may be prompted to create a unique identification by inputting preliminary data. Preliminary data may consist of—among other information—name, age, place of residence, and social media account access information. Preliminary data may include information related to the creator's website, accounts on social media platforms such as Instagram, Tik Tok, Facebook, Youtube, and any other third-party platform social media platform or website on which the creator's content is or may be featured. The preliminary data may include creator “handle(s),” i.e. username(s), followers, subscribers, views, and other data related to the creator's following and the level of interest in their content. The creator 50 may be prompted to grant the brand 60 authority to access private data held by third-party platforms. The preliminary data and unique identification 52 may be saved in a non-volatile format on a preliminary data database 184.

API connectors 190 may be Web APIs providing machine readable data and functionality transfer between web-based systems. API connectors 190 may be hosted on the brand module or application server. API connectors 190 may be written to request responses from a third-party platform. An API connector 190 is a software module enabling connection between a social network endpoint, handling such details as authentication, authorization, and network communication. The API connectors 190 are responsible for brokering communication between the brand module 100 and a content platform server 110. “Third party” may be used herein to designate a website or platform operated by a person or person(s) other than the brand or creator. An API connector 190 may be written to communicate with API connector 190 may deliver requests and receive responses from servers using Hypertext Transfer Protocol (HTTP), XML, or other protocol.

Multiple API connectors 190 may exist on the server, each connector written to interact with a specific website's API endpoint 112, requesting and extracting creator metric data. The API connector 190 requests a website data via the website's API endpoint 112. The connector will extract creator metric data made available by the website's API 112. The creator metric data may be publicly accessible, or private data a creator 50 has authorized the brand 60 to access during the onboarding process or otherwise via the creator interface 180. Creator metric data may be confirmed preliminary data, corrected preliminary data, or additional data related to the creator's profile and the creator's content published on that website, and other available metric data. For example, an Intagram API connector 190 may be written to interact with Facebook®/Instagram®'s API. API connector(s) 190 may be written for the Facebook® Graph API to request creator metric data related to published photos, post and story views, comments and comment replies; measuring media and profile interaction, hashtags, @mentions, reports, and other creator profile related statistics.

Extracted creator metric data may be transmitted back onto the brand module 100. The creator metric data may be stored in a metric database 192. The metric database 192 may store the data in a non-volatile, machine readable format.

The tag module 194 may live on the brand module 100. The tag module 194 may be able to process data based on criteria provided by the brand 60. The tag module 194 may access creator metric data from the metric database 192. The creator metric data may be processed by a tag module 194. Processing may include running data through models and algorithms that pertain to a creator's credentials as a content creature and/or brand endorser. One or more algorithms may integrate criteria chosen by the brand 60 as indicative of a creator's 50 endorsement and/or content creation potential. Criteria for an exemplary tag module 194 process may include followers, follower interaction rate ((likes+comments)/followers), and views in the last 6 months. The creator tag for a creator with 50,000 followers, a 3% follower interaction rate, and 300,000 views in the last month may be given a creator tag of 6, whereas a creator with 25,000 followers, 3% follower interaction rate, and 130,000 views in the last six months may be given a creator tag of 4. Greater creator tags may qualify creators for more promotional projects, i.e. higher paying projects, greater pay for the same project, and/or higher discount rates on the brand's products. Processing may produce a creator tag. The creator tag may correspond to the creator's endorsement potential, as determined by the criteria provided by the brand.

The creator tags may be indexed and stored in a tag database 196. Creator tags may be indexed into tiers, with the higher tiers qualifying for more promotions. Certain creator tags and/or tiers may qualify creators for more promotions, i.e. higher paying projects, greater pay for the same project, and/or higher discount rates on the brand's products. “Promotion” or “promotions” is used herein to denote any off made by a brand to a creator. Examples of a promotion include, but are not limited to: promotion may be a discount, an offer to join brand's pro team, an offer to provide the brand with content.

Brands may upload projects to a project module 220 via a brand interface 160. The brand 60 may input details of the project and a creator tag or tags that qualify for the project. The project module 220 may generate a project key for each qualifying creator. The project key may be sent to an offer node 181. The offer node 181 may be accessible through the creator interface 180. The project key may be stored in the offer node for a predetermined amount of time. The project key may enable the creator to accept or reject the project. The promotional project module 220 may send a notification of the project key to some or all qualifying creators. Notifications may be sent to a third-party communications server 140, such as the creator's personal email account, or through a message node 182 built into the app that enables the creator to access it through a creator interface.

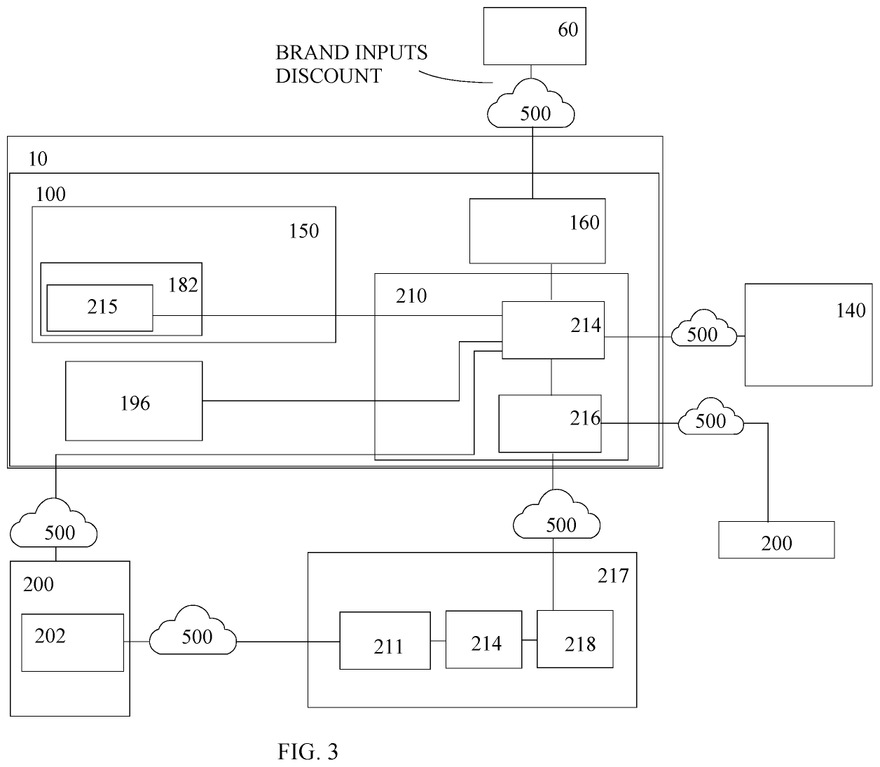

FIG. 3 depicts a discount subsystem of the app. The brand 60 may offer a creator or creators with certain creator tags a discount to products on the brand's website 200 or third party vendor. The discount may apply to all the brand's products, or a specific product or class of products. Via the brand interface 160, the brand 60 may input discount data into a discount module 210. Discount data may comprise percentage off products or services, free products or services, or other reductions in price to the brand's 60 products and serves, the creator tags that qualify for the reduction, creator metrics that qualify a creator for the reduction, and other criteria.

The discount data may be input into a discount database 214. The discount database 214 may call on the creator tag database 196 and request all creators 50 that qualify for the discount. The discount database 214 may generate a discount key. The discount may be sent to either or both the qualifying creator's offer node 181 or a third party communications server 140, such as the creator's personal email account. The discount key may allow the creator 50 to redeem the discount immediately. Alternatively, the redemption of the discount may be contingent on completion of another act by the creator 50.

The discount key may be sent to the brand website 200. The discount key may be saved on a website discount database 202 on the website 200 server. The creator 50 may be prompted to enter the discount key at the website 200 point of sale. Alternatively, the brand-side discount key may be automatically activated when the creator 50 logs onto the website 200, allowing the creator 50 to redeem the discount.

Alternatively, the brand 60 may use a third party e-commerce platform 120 to enable redemption of the discount. A third-party e-commerce API call 216 may transmit the discount key to the third party e-commerce platform server via a platform endpoint API. Creation of the promotion key may activate an e-commerce platform API connector 216 module. An e-commerce API call 216 may transmit the discount key to the third party e-commerce platform server 217 via a platform endpoint API. The API connector 216 may transmit the discount data as a brand-side discount key to the brand's third-party e-commerce platform. The brand-side discount key may contain the data necessary for the website to create the discount and identify the creator(s) that qualify for the discount. The brand-side discount key may be stored in discount database 214 on the third-party e-commerce platform server. The discount data and discount code may be stored in the discount database and/or automatically transferred to a website discount database 202 on the brand's website, where they may be stored in a website discount database 202.

The creator 50 may be able to automatically redeem the discount key by logging into the creator's account. The brand-side discount key stored in the website discount database 202 the brand website's 200 identification login system may communicate with the website to identify a qualifying creator. Cookies may also be used to identify a qualifying creator and activate the brand-side discount key. In a non-automated activation embodiment, the creator 50 may be prompted to manually enter the discount key at the point of sale or some other stage in the purchase process.

Alternatively, if the brand does not use a third party e-commerce platform server 217, the discount module 210 may send a discount key to the creator and a brand-side discount key directly to the brand website 200. The brand-side discount key stored in the website discount database 202 the brand website's 200 identification login system may communicate with the website to identify a qualifying creator. Cookies may also be used to identify a qualifying creator and activate the brand-side discount key. In a non-automated activation embodiment, the creator 50 may be prompted to manually enter the discount key at the point of sale or some other stage in the purchase process.

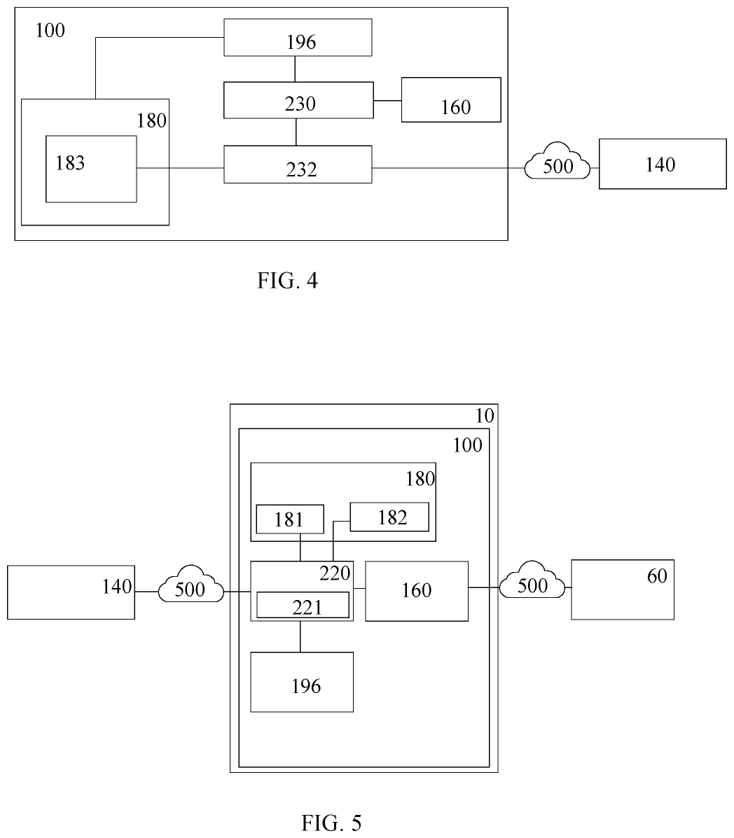

A subsystem of the app may enable a brand to select a creator for its brand team (see FIG. 4). The brand interface 160 may enable a brand to input criteria into a pro team module 230. The Pro Team Module may request a creator tag from the creator tag database 196. All relevant metric data comprising the creator tag may be algorithmically processed or otherwise analyzed by the pro team module 230. Analysis may result in the creator being qualified or disqualified for the pro team. If the creator qualifies, the pro team module 230 may generate a pro team key. The pro team key may require creator activation before the system designates the creator a member the pro team. The pro team key activation invitation may be transmitted to the creator's email or a communication node of the application. Activation of the pro team key may generate a change in the creator tag. The change may embed additional identification data in the creator's creator tag. The change in the creator tag may automatically qualify the creator for additional discounts and other promotional projects.

The pro team module 230 may generate an additional identification data to the creator's creator tag, the altered creator tag to be stored in the creator tag database 196. The additional identification data may activate automatic qualification for additional discounts and projects.

A subsystem of the app may enable the brand utilization of the creator tag database 196 to select a creator for a promotional project (see FIG. 4). The brand 60 may enter a project into a project database 221 via the brand interface 160. A project may be entered as project data related to content creation, compensation for the project, and deadline to submit drafts and the final iteration of the project, and qualifying creator metrics and or creator tags. The project may be stored as pending in the project module 220. The brand interface 160 may enable the brand 60 to activate the project. On activation, the project module 220 may request the project data from the project database 221. The project module 220 may process the project data and request qualifying creators from the creator tag database 196. The creator tag database 196 may transmit qualifying creator tags to the project module 220. The project module 220 may generate a project for each qualifying creator. The project key may be transmitted to the offer node 181 on the creator interface. The project key may contain project details, such as costs and project content requirements, and may enable the creator to accept or reject the project. The project module 220 may send notification of the project key to the creator's third-party communication server 140 and/or the message node 182. The creator may be able to accept or reject the project by accessing the project key in the offer node 181. If the creator 50 accepts the project, a command may be sent to the project module 220. The project status may be changed from pending to fulfilled in the project module 220. A notification may be transmitted to the brand interface 160, informing the brand 60 of the creator's 50 acceptance of the project.

Alternatively, if the creator rejects a project, a rejection command may be transmitted to the project module 220. The rejection command may activate the project module 220 to request additional creators that meet the creator metric requirements. Generation of the project key and transmission of the project key a creator's messenger node 182 may be repeated.

The project module 220 process the project data to create a creator hierarchy. The creator hierarchy may rank qualifying creatures based on desirability. Project keys may be sent out sequentially based on the creator hierarchy, to give the most qualified creatures the first opportunity to accept the project. The creator hierarchy may or may not correspond to the tiers.

If no qualifying creator accepts the project, the project module 220 may transmit a notification to the brand interface 160. The brand 60 may alter the creator metric requirements to broaden the pool of potential creators.

The brand 60 may set the qualifications for a project with greater specificity than simply a creator tag rating. For example, if a project calls for greater superficial popularity, the creator metric requirements may skew more towards followers on Instagram and Twitter followers. If the project involves the promotion of serious camera equipment, the brand may select creator metric requirements skewing more towards Youtube subscribers and views.

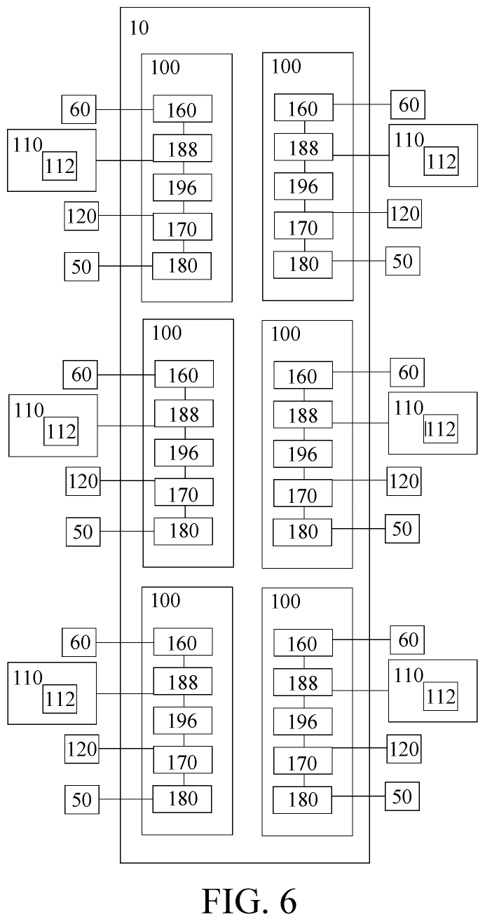

FIG. 6 depicts a high level view of multiple brand modules 100 on an application server. The application is scalable to any number of brand's. Other embodiments of the application may be native mobile app. A native mobile app embodiment may be installed directly onto a device. A promotion module 170 represents the one or more software modules capable of handling the input and storage of promotions. Examples of a promotion module are the discount module 210, project module 220, and pro team module 230, all discussed above.

The exemplary subsystems discussed above are all interconnected and discussed in isolation for demonstrative purposes. Subsystem functionalities may overlap or rely on other subsystems to perform their intended functionality. The foregoing disclosure is intended to be illustrative and not limiting the scope of the invention. Merely exemplary embodiments and methods related to the invention are discussed and described. As will be understood by those familiar to the art, the disclosed subject matter may be embodied in other forms or methods without departing from the essence of the invention.

I claim:

1. A method for selecting a content creator based on data retrieved from a third party website, comprising:
a. a server
b. an API connector capable of connecting with a third party site and withdrawing creator metric data;
c. a tag module as means of generating a creator tag;
d. a creator tag database capable of non-volatile storage of the creator tag;
e. an brand interface configured to enable the input of a promotional project;
f. the promotional project comprising qualification criteria;
g. a pairing module as means of matching the creator tag and the promotional project;

2. The application in claim 1, wherein the module is a project module communicatively coupled with the brand interface, whereby project data may be input, the project module being capable of storing said project data and matching said project data with a creator tag.

3. The application in claim 1, wherein the module is a discount module, the discount module capable of generating a discount key and transmitting the key to a sales platform.

4. A method of selecting a brand endorser, comprising:
a. a web-based application server configured to store a plurality of brand servers; [LEFT
b. each of the plurality of brand servers comprising:
i. a plurality of API connectors capable of capable of connecting with a third party site and withdrawing user metric data;
ii. a creator tag module;
iii. a promotions module;
iv. a creator interface;
c. each of the plurality of API connectors being configured to request and extract data from a web-based third party content platform;
d. the creator tag module configured to process extracted data and generate a creator tag therefrom;
e. a project module capable of matching an input project with a creator tag;
f. a discount module capable of matching an input discount code with a creator tag.

5. A software implemented method of selecting a brand endorser, comprising:
a. a server, the server hosting an API connector, a tag module, and a promotion module;
b. the API connector interfacing with an API endpoint to extract creator metric data;
c. a tag module processing the extracted creator metric data, whereby a user tag is created;
d. at least one promotion stored on the promotion module;
e. the promotion module as a means of matching a creator tag with the at least one promotion.
